(19) United States
(12) Patent Application Publication
(10) Pub. No.: US 2008/0204270 A1
(43) Pub. Date: Aug. 28, 2008

(54) MEASUREMENT-WHILE-DRILLING MUD PULSE TELEMETRY REFLECTION CANCELATION

(75) Inventors: Robert Anthony Aiello, Spring, TX (US); Jian-Qun Wu, Kingwood, TX (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: PRECISION ENERGY SERVICES, LTD., Calgary, AB (CA)

(21) Appl. No.: 11/678,287

(22) Filed: Feb. 23, 2007

(51) Int. Cl. G01V 3/20

(52) U.S. Cl. 340/855.4

(57) ABSTRACT

Method and apparatus for optimizing mud pulse telemetry data rate by processing a sequence of measured pulses to minimize adverse effects of pressure pulse reflections, attenuations and distortions. A downhole telemetry unit cooperating with a sensor and disposed in a MWD or LWD logging tool generates a sequence of pulse within the mud column. The sequence is encoder to represent the response of the sensor disposed within the logging tool. The encoded pulse sequence is sensed at the surface of the earth using a pressure transducer. The output of the transducer yields an electrical signal that is typically attenuated and can contain reflections and distortions. This measured signal output is processed to minimize the effects of pulse reflections, attenuations and distortions thereby yielding a primary pulse sequence that is more representative of the response of the sensor and allowing an increase in mud pulse telemetry data rate.

This invention is directed toward measurements made within a borehole, and more particularly directed toward a system for minimizing adverse effects of pulse reflections in mud pulse telemetry systems used in measurement-while-drilling (MWD) or logging-while-drilling (LWD) systems.

### BACKGROUND OF THE INVENTION

Measurements of various properties of earth formation penetrated by a well borehole are widely used in hydrocarbon and mineral exploration and production. In addition, measurements of borehole parameters are typically used in defining a path of the borehole, optimizing production from the borehole, and maintaining borehole integrity during and after drilling.

Many types of systems have been used to measure properties and parameters of earth formation penetrated by a borehole, as well as to measure properties and parameters related to the borehole itself. The first systems used downhole instruments or “tools” comprising one or more sensors. The tools were conveyed along the borehole by means of a “wireline” cable. In addition to a conveyance means, the wireline served as a communication conduit between the one or more sensors disposed in the downhole tool and equipment at the surface of the earth. The “surface equipment” typically processed measured sensor data to obtain parameters of interest as a function of depth within the borehole. These measurements as a function of depth, using wireline conveyance, are commonly referred to as “wireline well logs” or simply “wireline logs”. Logs relating to formation properties include measures of formation natural gamma radiation, thermal neutron flux, epithermal neutron flux, elastic and inelastically scattered neutron flux, capture gamma radiation, scattered gamma radiation, and the like. A variety of formation parameters are obtained from these measurements, or combinations of these measurements, such as shale content, porosity, density, lithology and hydrocarbon saturation. Logs relating to borehole properties include temperature, pressure, caliper, orientation and the like.

Wireline logging is applicable only after the borehole has been drilled. It was recognized in the 1960's that certain operational and economic advantages could be realized if formation and borehole properties measurements could be made while the borehole is being drilled. One or more sensors responsive to formation and borehole parameters are typically disposed near the lower end of a drill string and preferably within a drill collar. Systems for obtaining real time measures of borehole and drilling related parameters, as a function of depth, are generally referred to as measurement-while-drilling (MWD) systems. MWD systems measure properties and parameters such as weight on the drill bit, borehole orientation, and the like. Systems for obtaining real time measures of formation properties, as a function of depth, are generally referred to as logging-while-drilling (LWD) systems. LWD systems measure formation properties such as density, porosity, hydrocarbon saturation, permeability, and the like. The LWD measurements should conceptually be more accurate than their wireline counterparts. This is because the formation is less perturbed in the immediate vicinity of the borehole by the invasion of drilling fluids into the formation. This invasion alters the virgin state of the formation. This effect is particular detrimental to the more shallow depth of investigation measurements such as nuclear logging measurements.

As mentioned previously, the cable of a wireline system serves as a means for telemetering data between one or more sensors disposed in the tool and the surface of the earth. Wireline data transmission rates can be quite high. MWD and LWD systems can not rely on a cable as a means for telemetering sensor data to the surface. This is, of course, prevented by the rotation of the drill string used to convey LWD and MWD tools while drilling. One technique for transporting MWD and LWD to the surface is to record sensor response in the downhole tool, and to subsequently retrieve these data when the borehole assembly is returned to the surface of the earth or “tripped”. This method eliminates the observation of data at the surface in real time. Other types of MWD and LWD telemetry have been used to telemeter tool sensor data, in real time, to the surface of the earth. One type of telemetry is based upon electromagnetic transmission between the downhole tool and the surface. An example of an electromagnetic telemetry system is disclosed in U.S. Pat. No. 7,145,473. A second type telemetry is based upon acoustic transmission between the downhole tool and the surface using the drill string. An example of an acoustic telemetry system is disclosed in U.S. Pat. No. 6,847,585. A third type telemetry uses modulated pressure variations induced in the drilling fluid as a means for transmitting tool sensor data to the surface. Mud pulse telemetry will be discussed in detain in the following sections.

A borehole drilling operation typically uses drilling fluid commonly referred to as drilling “mud”. Drilling mud is pumped down the drill string, exits through ports in the drill bit, and returns to the surface via the drill string-borehole annulus. The mud is cleaned at the surface and recirculated throughout the drilling operation. During the drilling operation, the mud serves as a lubricant for the drill bit, as a means for returning drill bit cuttings to the surface, and as a means for provide pressure balance within the borehole.

As mentioned above, the drilling mud can function as a telemetry link between one or more sensors in the borehole tool and the surface of the earth. Mud telemetry systems are broadly classified as either mud pulse systems or continuous wave systems.

Mud pulse telemetry systems use valving to momentarily perturb mud flow through the downhole tool. This perturbation generates positive or negative pulses in the mud column within the borehole. The pulses are modulated to represent the response of a tool sensor. The modulated pulse sequence travels via the mud column to the surface where it is sensed by a pressure transducer. The output of the pressure transducer is demodulated thereby yielding a signal representative of the response of the downhole tool sensor. An example of a mud pulse telemetry system is disclosed in U.S. Pat. No. 5,586,084, which is incorporated into this disclosure by reference.

Continuous wave telemetry systems use a rotary valve or “mud siren” which restricts mud flow through the downhole tool to generate a positive pressure wave. As in the mud pulse system, the pressure wave is modulated to represent the response of a tool sensor, travels to the surface via the mud column, is sensed by a pressure transducer at the surface, and the output of the transducer is demodulated again yielding a signal representative of the response of the tool sensor. An example of a continuous wave telemetry system is disclosed in U.S. Pat. No. 3,309,656.

Using a mud pulse system as an example, pulse amplitude and frequency can be modulated to represent sensor response data. The pulse sequence degrades as it travels up the mud column to the surface. Attenuation, distortion and reflection cause this degradation. It is desirable to maximize data rates in order to maximize accuracy and precision of the data being telemetered. As data transmission frequency increases, the period for each individual pulse proportionally decreases. Data transmission rates are, therefore, limited by resolution requirements to separate and demodulate pulses at the surface. Pulse sequence degradation imposes further limitations on the period for each individual pulse thereby further reducing practical data transmission rates. As a result of all of these factors, typical mud pulse data transmission rates are limited to several pulses per second.

### SUMMARY OF THE INVENTION

The present invention is directed toward optimizing mud pulse telemetry data rate by processing a sequence of pulses, measured at the surface, in order to remove or at least minimize adverse effects of pressure pulse reflections. It is also important to note that these reflections can, and usually do, undergo attenuations and distortions. The process of minimizing adverse effects of pulse reflections, which also incorporates attenuation and distortion of these reflections, will be referred to as a pulse sequence filter. A downhole telemetry unit disposed in a MWD or LWD tool generates a sequence of pulse within the mud column. The sequence is encoder to represent the response of one or more sensors disposed within the logging tool. The encoded pulse sequence is sensed at the surface of the earth using preferably a pressure transducer disposed in the standpipe or swivel of a drilling rig. The output of the transducer is an electrical signal representative of the pulse sequence that is typically attenuated and can contain reflections and distortions. This measured signal output is processed to minimize the effects of pulse reflections, considering any attenuation and distortion of the pulse reflections, thereby yielding a “primary” pulse sequence. In the context of this disclosure, the terms “primary” pulse or “primary” pulse sequence refer to pulses that are measured preferably at the surface of the earth and that have been mathematically processed by pulse sequence filtering so that they closely represent pulses or pulse sequences generated by the downhole telemetry unit. Stated another way, “primary” pulses are pulses that are measured at the surface and have been mathematically processed to minimize perturbing factors associated with pulse reflections. With these perturbing factors minimized, the pulse period can be reduced while still maintaining the desired pulse resolution needed for pulse sequence demodulation. This, in turn, allows the data transmission rate to be increased.

### BRIEF DESCRIPTION OF THE DRAWINGS

So that the manner in which the above recited features, advantages and objects the present invention are obtained and can be understood in detail, more particular description of the invention, briefly summarized above, may be had by reference to the embodiments thereof which are illustrated in the appended drawings.

FIG. 1 is a conceptual illustration of a MWD logging system disposed in a borehole and cooperating with a rotary drilling rig;

FIG. 2 is a conceptual illustration of a primary sequence of encoded pulses generated by the downhole mud telemetry unit;

FIG. 3 is a functional flow diagram of the pulse sequence filtering methodology;

FIG. 4a is an actual mud pulse sequence that exhibits reflections; and

FIG. 4b shows the same pulse sequence after pulse sequence filtering illustrating the removal of the reflections.

### DETAILED DESCRIPTION OF THE PREFERRED EMBODIMENTS

The present invention is a system for optimizing data rate from LWD or MWD logging systems using pulse sequence filtering of mud pulse telemetry. Although LWD and MWD logging systems have different connotations in the art, the invention will de disclosed in the context of a MWD logging system. Its should be understood that the invention is equally applicable to LWD logging systems.

### Apparatus

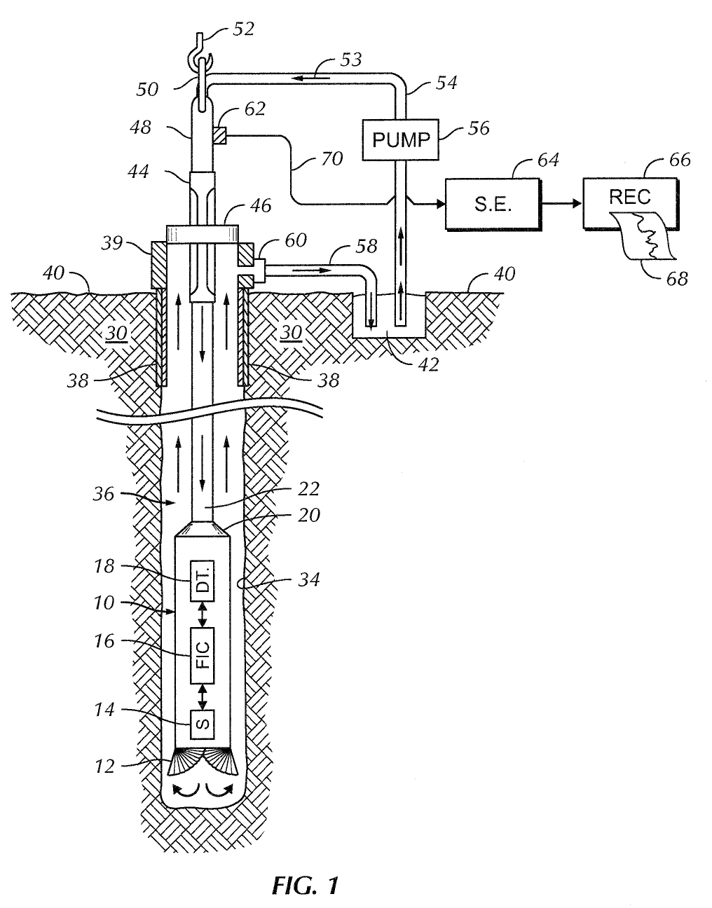

FIG. 1 is a conceptual illustration of a MWD logging system disposed in a borehole and cooperating with a rotary drilling rig. The borehole is filled with a column of drilling mud. The elements and the functionality of these elements will be disclosed in detail in this section.

Again referring to FIG. 1, a MWD logging tool 10 is suspended within the borehole 36. The lower end of the logging tool 10 is terminated by a drill bit 12, and the upper end is terminated by a suitable connector 20 which operationally connects the tool to the lower end of a drill string 22. The housing of the logging tool 10 is preferably a drill collar. One or more sensors 14 are disposed within the tool 10. These one or more sensors are responsive to parameters of interest such as formation properties, borehole conditions, tool orientation, and the like. The sensors are powered and controlled by a power and control section 16. A downhole mud telemetry unit 18 cooperates with the power and control section 16 to generate a sequence of pulses in the borehole mud column that is representative of the response of the one or more sensors 14.

Still referring to FIG. 1, the upper end of the drill string terminates at the lower end of a kelly 44. The upper end of the kelly 44 is operationally attached to a swivel 48 which is suspended from a traveling block (not shown) supported by a derrick (not shown). A rotary table 46 cooperates with the kelly 44 to rotate the drill string, logging tool 10, and drill bit 12 to advance the borehole 36. Drilling mud is pumped by a pump 56 from a source such as a mud pit 42 and through a conduit 54 such as a flexible hose, through the swivel 48, the kelly 44, the drill string 22, the tool 10, and enters the borehole 36 through orifices in the drill bit 12. The mud flow then returns to the surface of the earth 40 via an annulus formed by the outer surfaces the drill string 22 and the wall 34 of the borehole 36. The mud exits the borehole through an orifice 60 in the well head 39, which is typically attached to surface casing 38, and then flows into the mud pit 42 via a conduit 58. The mud flow path is illustrated conceptually with the arrows 57. Rotary drilling rigs are well known in the art, therefore elements of a typical drilling rig are not shown for clarity. In addition to the previously mentioned traveling block and derrick, elements of the mud system such as surge control device and mud cleaning apparatus (e.g. a “shaker table”) are not shown.

Again referring to FIG. 1, a pressure transducer 62 is shown disposed in the swivel 48 and hydraulically coupled to the drilling mud. The transducer senses the sequence of pulses induced in the borehole mud column by the downhole mud telemetry unit 18. It should be understood that the pressure transducer 62 can be disposed at other locations that are hydraulically coupled to the mud column. Recall that this sequence of pulses in indicative of the response of the one or more tool sensors 14. The output of the transducer 62 is an electrical signal indicative of sensor response. The electrical output is input into surface equipment 64 via a link 70. A processor within the surface equipment is preprogrammed to remove reflections and distortions from the measured pulse sequence thereby yielding a primary pulse sequence. This primary pulse sequence is then demodulated preferably within the processor and converted to a parameter of interest sensed by the one or more sensors 14. The parameter of interest is input to a recorder 66 and tabulated as a function of depth within the borehole at which it was measured thereby forming a “log” 68 of the parameter of interest. Pulse sequence data processing is discussed in detail in the following sections of this disclosure.

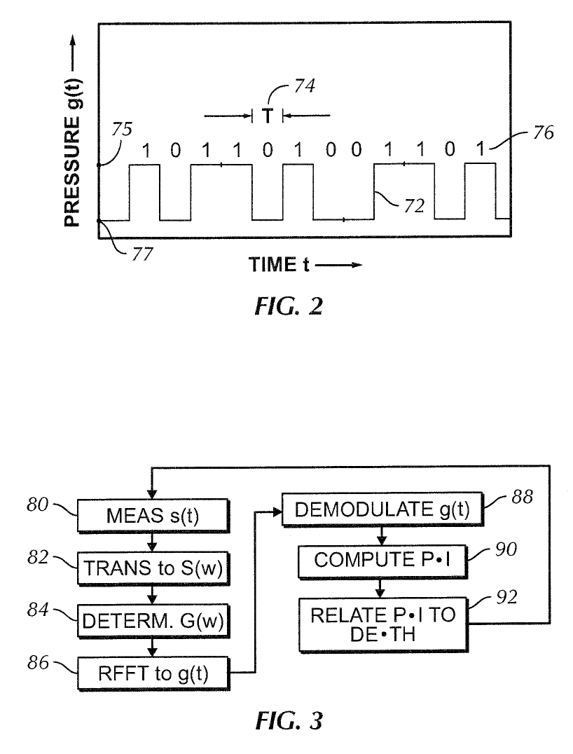

FIG. 2 is a conceptual illustration of a primary sequence of encoded pulses generated by the downhole mud telemetry unit 18. The illustration is a plot of primary pressure amplitude g(t) as a function of time t. The pulse sequence is of time duration T as illustrated at 74. In the modulation scheme of the conceptual illustration, a pulse of amplitude g(t) identified on the ordinate at 75 represents a binary 1, and a pulse of amplitude g(t) identified on the ordinate at 77 represents a binary zero. The pulse duration T must be sufficient large to allow the individual pulses in the sequence to be subsequently resolved and demodulated at the surface of the earth. It is emphasized that FIG. 2 is a conceptual illustration. In practice, the pulse sequence detected by the transducer 62 (see FIG. 1) at the surface 40 is degraded by attenuations and distortions. Furthermore, pulses can be partially reflected and these reflections can also be attenuated and distorted. The perturbing factors of pulse reflections, and their effects on a sequence of primary pulses, will be subsequently discussed and illustrated in this disclosure.

### Mathematical Formalism

As mentioned previously, mud pulse reflections can severely inhibit pulse detection, or at least force the telemetry data rate to decrease below desirable limits. There are two primary problems associated with reflection interference. The first problem is caused by an opposite sign reflection. An example would be a negative reflection in a sequence of positive primary mud pulses. The second problem is false pulse detection caused by a same sign reflection. An example would be a positive reflection in a sequence of positive mud pulses, where the amplitude of the reflected pulse is comparable to the amplitude of unreflected “primary” pulses. Reflection removal can help to obtain faster data rates. If primary pulses can be placed closer together (i.e. the pulse period T reduced), without interference from reflections, then data rate can be substantially increased. Stated another way, minimization of the pulse period T tends to maximize the data rate as long as resolution of individual pulses in the measured pulse sequence can be maintained. Reflected pulses can also be attenuated and distorted. Attenuation and distortion of reflected pulses must be considered in correcting for pulse reflections.

The adverse effects of pulse reflection are minimized using pulse sequence filtering. The following section sets forth mathematical algorithms used in pulse sequence filtering. It should be understood that the mathematical formalism can be varied while still performing the same mathematical functions and maintaining the desired results of the pulse sequence filtering concept.

Referring again to FIG. 1, the transducer 62 measures the amplitude of a sequence of modulated mud pulses as a function of time. Mathematically, the response of the transducer 62 is expressed as

s(t)=g(t)+cg(t−a). (1)

where:

t=time

s(t)=the measured signal from the response of the surface transducer;

g(t)=the primary pulse corrected for reflection and incorporating reflection attenuation;

g(t−a)=a reflection of the primary pulse delayed by a pulse sequence delay time parameter a; and

c=a pulse sequence parameter that is an amplitude multiplier to account for attenuation and/or sign reversal in the pulse reflection.

Equation (1) is more easily solved in the frequency domain. Equation (1) transformed into the frequency domain is

S(w)=G(w)+cG(w)e^{iaw}. (2)

where:

w=frequency

S(w)=the measured signal in the frequency domain;

G(w)=the primary pulse in the frequency domain; and

a and c are corresponding delay and amplitude terms defined above.

Solving equation (2) for G(w) yields

G(w)=S(w)/(1+ce^{-iaw}). (3)

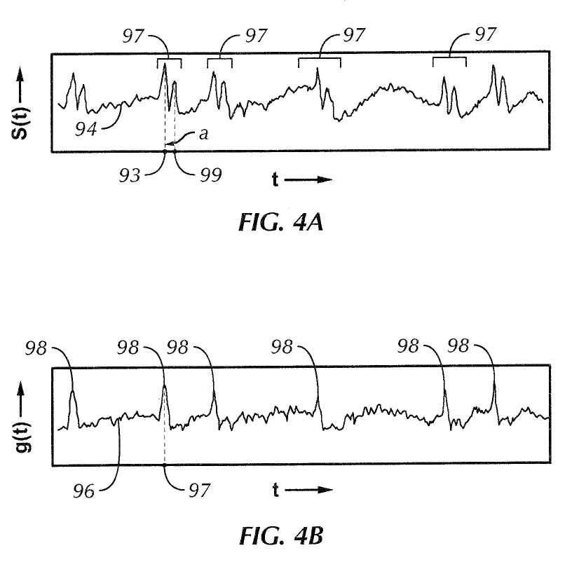

The term G(w) can be determined since everything on the right side of the equation is measured, known or can be calculated. More specifically, term S(w) is the Fast Fourier Transform of the measured signal, c is a measured or known reflected pulse attenuation factor and a is a measured or known delay of the reflection. An example of s(t) as a measured pulse sequence, from which measured pulse sequence parameters a and c can be determined, is illustrated in FIG. 4a. The primary pulse g(t) of equation (1), which is the pulse parameter of interest, is obtained by performing a Reverse Fast Fourier Transform of G(w) obtained from equation (3). Physically, g(t) is the mud pulse sequence corrected for the adverse effects of a reflection. The sequence of corrected mud pulses g(t) are then demodulated to obtain a signal representative of the response of a sensor 14 in a MWD logging tool 10 (again, see FIG. 1). Demodulation is preferably performed in a processor disposed in the surface equipment 64. The demodulated signal is converted to a parameter of interest, again preferably in the processor, and output to a recorder 66 and preferably tabulated as a function of depth thereby forming a “log” 68.

Equation (1) is applicable to a single reflector. In practice, the sequence of telemetered pulses can be adversely affected by a plurality of reflections. This situation is represented mathematically by expanding equation (1) as

s(t)=g(t)+c₁g(t−a₁)+c₂g(t−a₂)+ . . . +cₙg(t−aₙ) (4)

where:

t=time

s(t)=the measured signal from the response of the surface transducer;

g(t)=the primary pulse corrected for reflection and attenuation;

g(t−aⱼ)=a reflection j of the primary pulse delayed by time aⱼ; and

cⱼ=an amplitude multiplier to account for attenuation and/or sign reversal in the reflection j; where

j=1, 2, . . . , n; and

n=the number of reflections.

It is also important to expand equation (1) to include the possibility of distortion in a reflection. A distorted reflection is expressed mathematically in the time domain as

s(t)=g(t)+d(t)g(t−a) (5)

where:

t=time

s(t)=the measured signal from the response of the surface transducer;

g(t)=the primary pulse corrected for reflection and attenuation;

g(t−a)=a reflection of the primary pulse delayed by time a; and

d(t)=a measured pulse sequence parameter indicative of the distortion of the pulse reflection.

Expressing equation (5) in the frequency domain and again solving for G(w) yields

G(w)=S(w)/(1+D(w)e^{-iaw}). (6)

As in equation (3), everything on the right side of the equation (6) is measured, known or can be calculated. More specifically, term S(w) is again the Fast Fourier Transform of the measured signal, D(w) is a measured or known distortion term, and a is a measured or known delay of the reflection. As an example, the distortion term d(t) in the time domain, and thus the distortion term D(w) in the frequency domain, can be determined from the measure of a sequence s(t) in the same manner as the previously discussed terms a and c. The primary pulse sequence g(t) of equation (1), which is the pulse parameter of interest, is obtained by performing a Reverse Fast Fourier Transform of G(w) obtained from equation (6). Physically, g(t) is the measured mud pulse sequence corrected for the adverse effects of a distortion and a reflection delay a. Once again, the sequence of corrected mud pulses g(t) is then demodulated in the processor disposed in the surface equipment 64 to obtain a signal representative of the response of a sensor 14 disposed in a MWD logging tool 10. As discussed above, the demodulated signal is again converted to a parameter of interest, preferably in the processor, and output to a recorder 66 and preferably tabulated as a function of depth thereby forming a log 68.

Pulse sequence filtering for cancellation of pulse reflection is presented as a functional flow diagram in FIG. 3. The response of the surface transducer 64, s(t), is measured at 80. The transducer response s(t) is transformed to the frequency domain S(w) at 82. G(w), the primary pulse in the frequency domain, is obtained at 84. At 86, a Reverse Fast Fourier Transform of G(w) yields the primary pulse sequence g(t). The primary pulse sequence g(t) is demodulated at 88, and a parameter of interest measured by the sensor 14 is determined from the demodulation at 90. At 92, the parameter of interest is related to and tabulated as a function of a depth at which it was measured thereby forming a log of the parameter of interest. It should be understood that the flow diagram is only a conceptual illustration of the pulse reflection correction. Steps addressing multiple reflections (see equation (4)) and distortions of these reflections (see equation (5)) are not illustrated as separate steps in the mathematical formalism.

### Results

FIG. 4a is a plot of a measured signal s(t) from a pressure transducer as a function of time t. The curve 94 illustrates pairs of primary and reflected pulses denoted by the excursions 97. As an example, a primary pulse g(t) occurs at a time t denoted as 93, and a reflected pulse occurs at a time t denoted as 99. The primary and reflected pulses are separated by the previously defined delay time interval a. As discussed previously, the delay time interval a can be obtained from the measured signal sequence shown in FIG. 4a. Furthermore, an amplitude multiplier c indicative of attenuation of the reflected pulse, as previously defined, can be obtained by comparing amplitudes of primary and reflected pulsed occurring at times 93 and 97, respectively.

FIG. 4b is a plot of a primary pulse sequence g(t) as a function of time t obtained by pulse sequence filtering the measured pulse sequence s(t) shown in FIG. 4a. The curve 96 exhibits only primary pulse excursions 98. As an example, observe the pair of excursions occurring at times 93 and 97 shown in curve 94 of FIG. 4a. After pulse sequence filtering of the curve 94, the reflected pulse occurring at time 99 has been removed leaving only the primary pulse 98 occurring at time 97. Generally speaking, the pulse sequence filtered curve 96 exhibits only primary pulses g(t) exhibited as the excursions 98.

While the foregoing disclosure is directed toward the preferred embodiments of the invention, the scope of the invention is defined by the claims, which follow.

What is claimed is:

1. A pulse sequence filter method comprising:
(a) transforming a measured pulse sequence in the time domain to a measured pulse sequence in a frequency domain;
(b) combining said measured pulse sequence in the frequency domain with one or more measured pulse sequence parameters to obtain a primary pulse sequence in the frequency domain; and
(c) transforming said primary pulse sequence in the frequency domain to obtain a primary pulse sequence in the time domain.

2. The method of claim 1 wherein at least one said pulse sequence parameter is a delay time of reflected pulses.

3. The method of claim 2 wherein at least one said pulse sequence parameter is representative of an amplitude multiplier of said reflected pulses or a distortion of said reflected pulses.

4. A method for obtaining a primary pulse in a time domain from a response of a transducer, the method comprising:
(a) measuring a signal from said transducer to obtain a measured signal in the time domain;
(b) transforming said measured signal in the time domain to a measured signal in a frequency domain;
(c) combining said measured signal in the frequency domain with one or more measured pulse sequence parameters to obtain a primary pulse in the frequency domain; and
(d) transforming said primary pulse in the frequency domain to obtain said primary pulse in the time domain.

5. The method of claim 4 wherein said pulse sequence parameters comprise a pulse reflection delay time and an amplitude multiplier or a pulse sequence parameter indicative of pulse distortion.

6. The method of claim 5 wherein said pulse sequence parameters comprise a plurality of said pulse reflection delay times and a plurality of said amplitude multipliers.

7. The method of claim 4 wherein at least one said pulse sequence parameter comprises a pulse reflection delay time.

8. The method of claim 4 wherein said pulse sequence parameters comprise a pulse reflection delay time and an amplitude multiplier and a pulse sequence parameter indicative of pulse distortion.

9. A method for obtaining a parameter of interest with a MWD system employing mud pulse telemetry, the method comprising:
(a) disposing a sensor within a logging tool of said MWD system;
(b) within a mud column, encoding a sequence of pulses indicative of a response of said sensor;
(c) with a pressure transducer disposed at the surface of the earth and hydraulically coupled to said mud column, measuring said sequence of pulses indicative of response of said sensor to obtain a measured signal in a time domain;
(d) transforming said measured signal in the time domain to a measured signal in a frequency domain;
(e) combining said measured signal in the frequency domain with one or more measured pulse sequence parameters to obtain a primary pulse sequence in the frequency domain;
(f) transforming said primary pulse sequence in the frequency domain to obtain said primary pulse sequence in the time domain;
(g) demodulating said primary pulse sequence in the time domain to determine said parameter of interest.

10. The method of claim 9 wherein at least one said pulse sequence parameter comprises pulse reflection delay time and at least one additional said pulse sequence parameter is selected from a group comprising amplitude multipliers and pulse sequence parameters indicative of pulse distortion.

11. The method of claim 9 further comprising transforming said measured signal in the time domain into said measured signal in a frequency domain using a fast Fourier transform.

12. The method of claim 9 further comprising transforming said primary pulse sequence in the frequency domain into said primary pulse sequence in the time domain using a reverse fast Fourier transform.

13. A MWD system comprising:
(a) a sensor disposed within a logging tool;
(b) a mud pulse telemetry system for encoding a sequence of pulses indicative of a response of said sensor;
(c) a pressure transducer for measuring said sequence of pulses indicative of response of said sensor to obtain a measured signal in a time domain; and
(d) a processor for
(i) transforming said measured signal in the time domain to a measured signal in a frequency domain,
(ii) combining said measured signal in the frequency domain with one or more measured pulse sequence parameters to obtain a primary pulse sequence in the frequency domain,
(iii) transforming said primary pulse sequence in the frequency domain to obtain a primary pulse sequence in the time domain, and
(iv) demodulating said primary pulse sequence in the time domain to determine a parameter of interest.

14. The system of claim 13 wherein at least one said pulse sequence parameter is a pulse reflection delay time and at least one additional said pulse sequence parameter is selected from a group comprising amplitude multipliers and pulse sequence parameters indicative of pulse distortion.

15. The system of claim 13 wherein said measured signal in the time domain is transformed into said measured signal in a frequency domain using a fast Fourier transform.

16. The system of claim 13 wherein said primary pulse sequence in the frequency domain is transformed into said primary pulse sequence in the time domain using a reverse fast Fourier transform.
